(19) United States
(12) Patent Application Publication
(10) Pub. No.: US 2005/0156131 A1
(43) Pub. Date: Jul. 21, 2005

(54) Fire resistant valve assemblies

(76) Inventor: David G. Holliday, Spring, TX (US)

Correspondence Address: BAKER BOTTS, LLP, 910 LOUISIANA, HOUSTON, TX, 77002-4995, US

(21) Appl. No.: 11/034,045

(22) Filed: Jan. 12, 2005

Related U.S. Application Data
(60) Provisional application No. 60/536,959, filed on Jan. 16, 2004.

(51) Int. Cl. F16K 3/00

(52) U.S. Cl. 251/326

(57) ABSTRACT

A gate valve assembly having: a flowway; a cavity intersecting the flowway; a slab gate movable within the cavity between an open position, a closed position, and a relief position such that the open position allows fluid flow through the flowway, the closed position restricts fluid flow through the flowway, and the relief position allows fluid flow between the cavity and the flowway; a stem in mechanical communication with the slab gate so as to move the slab gate between the open position and the closed position; a retainer in mechanical communication with the slab gate so as to control movement of the slab gate between the closed position and the relief position, the retainer changing from a solid to one of a liquid or gas in the presence of heat; and a biaser of the slab gate toward the relief position.

### REFERENCE TO PRIOR APPLICATIONS

This application claims the benefit of U.S. Provisional Application No. 60/536,959, filed Jan. 16, 2004.

### BACKGROUND OF THE INVENTION TECHNOLOGY

1. Field of the Invention

The present invention is related to gate valve assemblies.

2. Description of the Related Art

Christmas Trees include a series of valves that may direct fluid flow from a producing well. Typically, Christmas Trees may be placed in close proximity to each other. A fire on one Christmas tree may not only damage the Tree on fire, but may also damage other Trees in close proximity. Consequently, fire resistant valves on Christmas Trees are desirable.

API Specifications 6FA and 6FC were developed by the American Petroleum Institute (API) to verify that a gate valve may be subject to a short duration fire with minimal leakage. Under API Specifications 6FA and 6FC tests, the upstream pressure of a valve in a Christmas Tree must be maintained at a set pressure, which simulates the well bore pressure. When the lower master valve is in the open position, the upper master valve will be exposed to the upstream pressure. Consequently, during an actual fire on a Christmas Tree the lower master valve and the upper master valves may be the only valves that are capable of being maintained at the set pressure. As the Christmas Tree is heated in a fire, the upper master valve may close and seal the well. Further, the wing valve may close as the upper master valve closes. Following the closure of these valves, a volume of liquid becomes trapped between the upper master valve, the wing valve, and the already closed swab valve. As the fire progresses the trapped fluid will become heated, and its pressure will increase to such an extent that the valve may become damaged and begin leaking.

### SUMMARY OF THE INVENTION

In general, in one aspect, this invention features a gate valve comprising a flowway and a cavity intersecting the flowway. The gate valve may further comprise a slab gate movable within the cavity to one of an open and several closed positions. The closed positions may include one of a closed sealed and closed pressure relief position. The slab gate may include a weep hole communicating between the cavity and the flowway when the slab gate is in the closed pressure relief position.

According to one aspect of the invention, there is provided a gate valve assembly having: a flowway; a cavity intersecting the flowway; and a slab gate movable within the cavity between an open position, a closed position, and a relief position such that the open position allows fluid flow through the flowway, the closed position restricts fluid flow through the flowway, and the relief position allows fluid flow between the cavity and the flowway.

A further aspect of the invention provides a gate valve assembly having: a flowway; a cavity intersecting the flowway; a slab gate movable within the cavity between an open position, a closed position, and a relief position such that the open position allows fluid flow through the flowway, the closed position restricts fluid flow through the flowway, and the relief position allows fluid flow between the cavity and the flowway; a stem in mechanical communication with the slab gate so as to move the slab gate between the open position and the closed position; a retainer in mechanical communication with the slab gate so as to control movement of the slab gate between the closed position and the relief position, the retainer changing from a solid to one of a liquid or gas in the presence of heat; and a biaser of the slab gate toward the relief position.

According to still another aspect of the invention, there is provided a method for controlling fluid flow through a flowway, the method having the following steps: intersecting a cavity with the flowway; positioning a slab gate across the flowway, wherein the slab gate has open, closed, and relief positions such that the open position allows fluid flow through the flowway, the closed position restricts fluid flow through the flowway, and the relief position allows fluid flow between the cavity and the flowway; maintaining the slab gate in the closed position with a retainer; removing the retainer; and biasing the slab gate toward the relief position.

### BRIEF DESCRIPTION OF THE DRAWINGS

A more complete understanding of the present disclosure and advantages thereof may be acquired by referring to the following description taken in conjunction with the accompanying drawings wherein:

FIG. 1 is a block diagram of one example Christmas Tree including a gate valve according to the present invention;

FIG. 2 is an embodiment showing a gate valve assembly in the open position according to the present invention;

FIG. 3 is an embodiment showing a gate valve assembly in the closed sealed position according to the present invention;

FIG. 4 is an embodiment showing a gate valve assembly in the closed pressure relief position according to the present invention; and

FIG. 5 is another embodiment showing a gate valve assembly in the closed pressure relief position according to the present invention.

The present invention may be susceptible to various modifications and alternative forms. Specific embodiments of the present invention are shown by way of example in the drawings and are described herein in detail. It should be understood, however, that the description set forth herein of specific embodiments is not intended to limit the present invention to the particular forms disclosed. Rather, all modifications, alternatives and equivalents falling within the spirit and scope of the invention as defined by the appended claims are intended to be covered.

### DETAILED DESCRIPTION OF SPECIFIC EMBODIMENTS

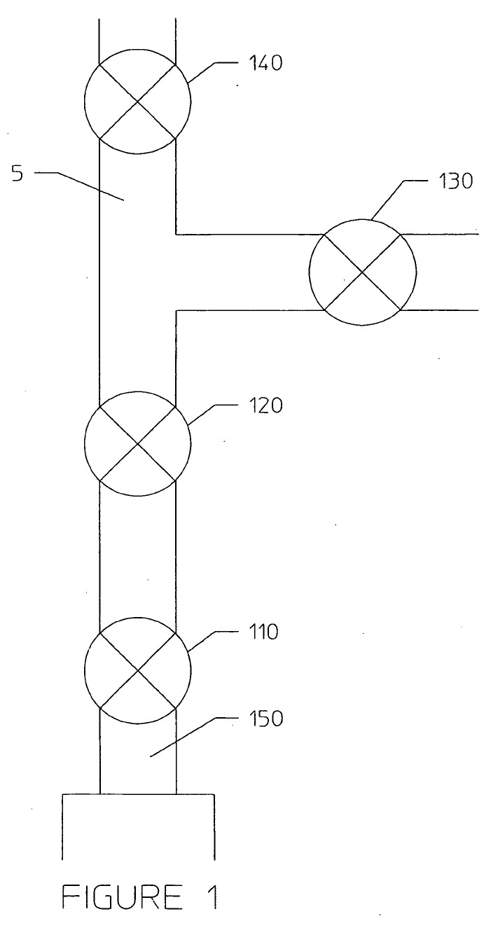

The details of the present invention will now be described with reference to the figures. Turning to FIG. 1, a block diagram of a Christmas Tree having four valves is depicted. A Christmas Tree may include a series of valves to direct and control fluid flow. The example Christmas Tree shown in FIG. 1 includes a lower master valve 110, an upper master valve 120, a wing valve 130, and a swab valve 140. The valves 110, 120, 130, and 140 are connected by flowway 5. Lower master valve 110 may communicate with well bore 150.

During a fire on a Christmas Tree with valve 110 open and valve 140 closed, valves 120 and 130 may close and trap a volume of liquid between upper master valve 120, wing valve 130, and swab valve 140. If valve 110 and valve 120 are closed, a volume of liquid would be trapped between those valves as well. As the fire progresses, the increase in fluid temperature increases the pressure of the trapped fluid. To relieve the increase in pressure of the trapped liquid, the disclosed invention provides a mechanism for venting the trapped pressure that exceeds the well bore pressure upstream into well bore 150, while maintaining the seal on the downstream side of the valve gates. In one embodiment, upper master valve 120 may vent pressure toward its upstream, well bore side 150 during a fire. In another embodiment, one or more of lower master valve 110, upper master valve 120, swab valve 140, and wing valve 130 may vent pressure toward its respective upstream well bore side 150.

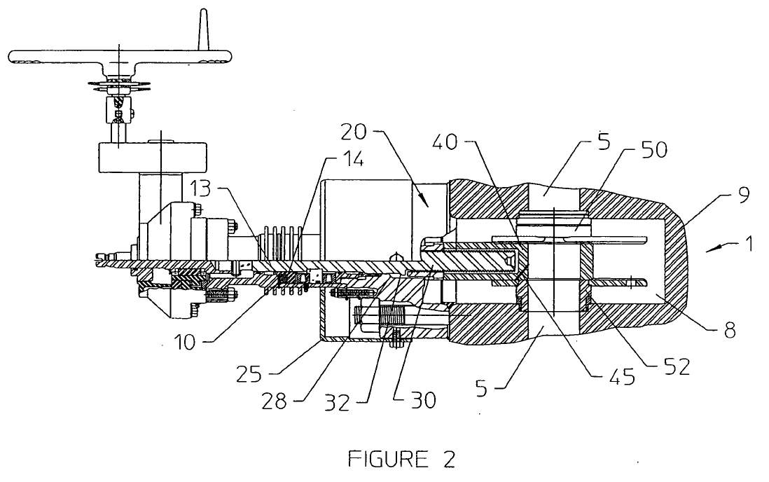

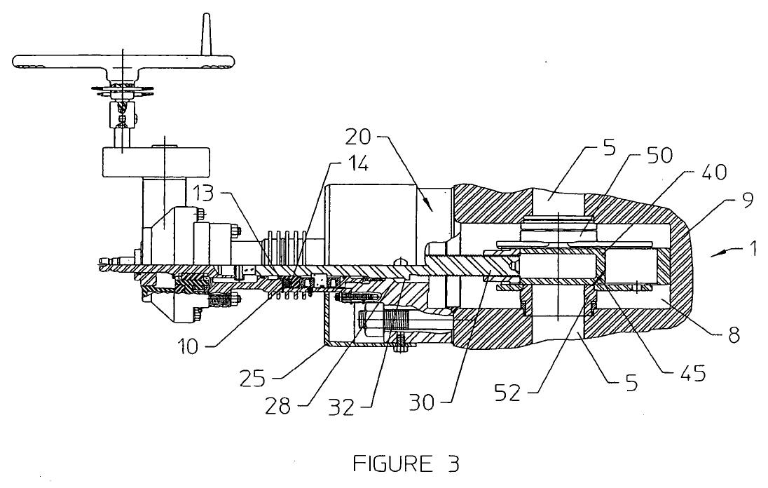

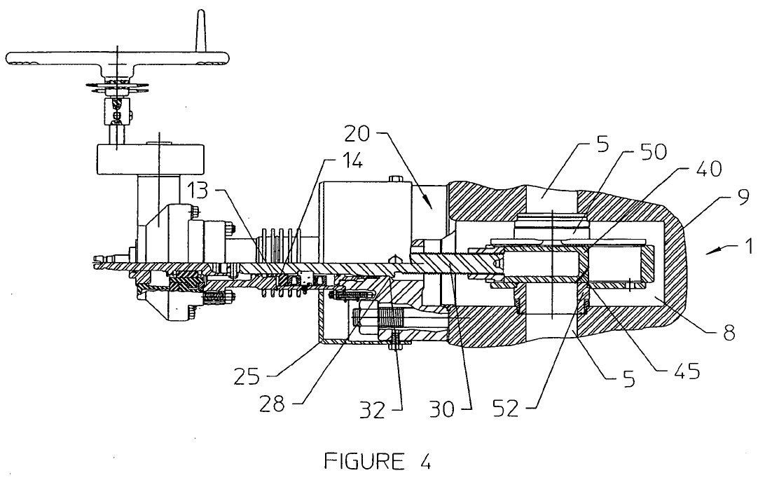

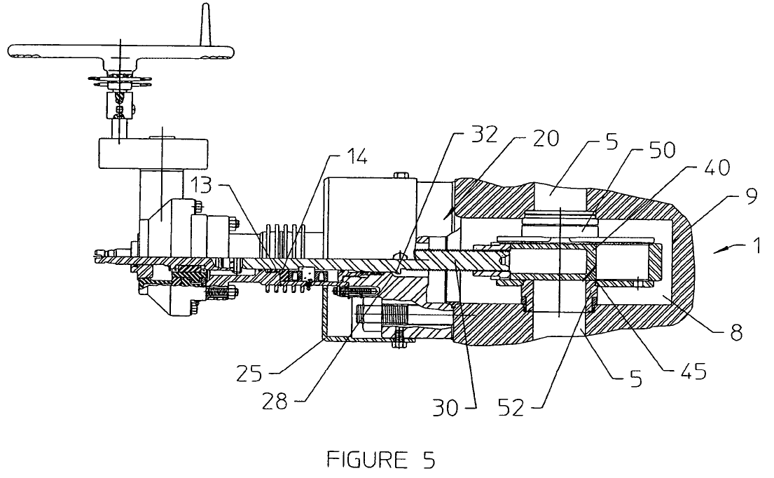

One embodiment of a fire resistant gate valve assembly (denoted generally as 1) is depicted in FIG. 2. Slab gate valve assembly 1 includes a flowway 5 and a cavity 8 having edge 9. A slab gate 40 may traverse cavity 8. Slab gate 40 may be in one of an open position (FIG. 2), a closed sealed position (FIG. 3), or a closed pressure relief position (e.g., FIGS. 4, 5). When in the closed sealed position (FIG. 3), the gate blocks fluid flow through the flowway 5 in both directions. Slab gate 40 may include a weep hole 45 that may communicate between cavity 8 and flowway 5 when the gate is in the closed pressure relief position (e.g., FIGS. 4, 5). When in the closed pressure relief position (e.g., FIGS. 4, 5), the gate blocks fluid through the flowway 5 from the upstream well bore side 150, but will pass fluid flow to the upstream well bore side.

In the open position, the gate permits flow through flowway 5. A stem 30 contacts the gate to move the gate from the open position to the closed sealed position. Slab gate 40 may include a hole that when mated with upper seat 50 and lower seat 52 permits fluid flow through flowway 5. Upper seat 50 seals the downstream side of slab gate 40, and lower seat 52 seals the upstream side of slab gate 40. In one embodiment, a metal to metal seal between the slab gate and the seats 50 and 52 may be formed by coating the surfaces of slab gate 40 and seats 50 and 52 with tungsten carbide and lapping the surfaces to form a surface of desired smoothness. Fire resistant valve assembly may also include a bonnet 20. In the open position, the gate abuts the bonnet and remains stationary.

Fire resistant gate valve assembly 1 may also include a retainer of the slab gate. The retainer may be any block, ring, key, pin, fastener, or any other retention device known to persons of skill. In one embodiment, the retainer is a meltable ring 10 that may change from a solid to a liquid or a gas in the presence of a heat source such as a fire. In one embodiment, meltable ring 10 may comprise a composition of lead (Pb) and Bismuth (Bi). Alterations in the meltable ring's composition may change the melting temperature of the ring. Consequently, meltable ring 10 may transform itself from a solid into a liquid or gas when the temperature exceeds a threshold. For example, the composition of Pb and Bi may be chosen such that the meltable ring's material melts at a temperature of about 255° F. In one embodiment, meltable ring may be an eutectic ring.

Stem 30 of valve assembly 1 may include a stem backseat 32, and bonnet 20 may further include a bonnet backseat 28. Bonnet shroud 25 may surround bonnet 20 to minimize damage to the components of the shroud, such as bolts, during a period of elevated temperature. The backseats 32 and 28 may limit the movement of stem 30 following the melting of meltable ring 10 during a period of elevated temperature such as a fire. For example, if meltable ring 10 melts, stem 30 and gate 40 may shift in bonnet 20 until stem backseat 32 contacts bonnet backseat 28. In another embodiment, gate 40 may shift in bonnet 20 until sleeve 14 bottoms out against bonnet cap shoulder 13 prior to the backseats 28 and 32 contacting.

Valve assembly 1 in the closed sealed position is depicted in FIG. 3. FIG. 3 is similar to FIG. 2, with the exception that slab gate 40 is in the closed sealed position. Similar to FIG. 2, the valve assembly shown in FIG. 3 includes meltable ring 10, bonnet 20, bonnet shroud 25, bonnet backseat 28, stem 30, stem backseat 32, sleeve 14, bonnet cap shoulder 13, cavity 8, flowway 5, upper seat 50, lower seat 52, and weep hole 45. Furthermore, the edge of slab gate 40 may abut, or contact edge 9 of cavity 8. Upper seat 50 and lower seat 52 permit leakage of pressure from flowway 5 into cavity 8. Consequently, in the closed position, the pressure in cavity 8 will be approximately equal to the higher pressure of the upstream or downstream side of the seats. Because weep hole 45 does not communicate with flowway 5 in the closed position, an increase in the pressure of cavity 8 may not vent through weep hole 45 into flowway 5.

Depending on the particular application, the valve assembly has a biaser of the slab gate that biases the slab gate toward a relief position. In the relief position, the cavity is in fluid communication with the flowway. Again, depending on the particular application, the relief position of the slab gate may allow fluid communication between the cavity an either the upstream side of the flowway, the downstream side of the flowway, or both sides of the flowway. In some embodiments, the biaser is a slab gate configuration with surfaces exposed to the cavity such that fluid pressure in the cavity acts on the surfaces to apply a force to the slab gate.

In an opened position, valve assembly 1 is a bi-directional valve permitting fluid flow in either direction of flowway 5. In one embodiment according to the present invention, valve assembly 1 may be a bi-directional gate valve that, when exposed to a fire transforms itself into a unidirectional valve. In a closed sealed position, the gate valve prevents flow in any direction through flowway 5. But in the presence of fire, meltable ring 10 melts and then pressure in cavity 8 urges stem 30 to shift up in the bonnet, which in turn causes the gate to shift up, and thereby permitting weep hole 45 to communicate between the upstream portion of flowway 5 and cavity 8.

As a result, the gate valve may transform itself from a bi-directional gate valve to a unidirectional valve by melting a meltable ring in a fire. When the stem and gate have shifted in the bonnet, a weep hole, located in the gate, may become positioned such that one end of the weep hole may be located in the valve's body cavity and the other end of the weep hole may be located in the valve's upstream (down hole) bore. In this position, the valve's body pressure may remain the same as the well's bore pressure. When in the unidirectional mode of operation, any pressure on the down stream side of the valve may vent past the downstream seat and into the valve's body cavity and then through the weep hole in the gate down into the upstream well bore 150 (see FIG. 1). The shifting of the stem and gate in the presence of heat may reduce valve damage due to over pressurization as the contained fluid becomes heated. One skilled in the art with the benefit of this disclosure will recognize that lower master valves, upper master valves, and swab valves may include this feature.

FIG. 4 depicts an embodiment of the gate valve assembly in the closed pressure relief position. FIG. 4 does not include a meltable ring because FIG. 4 assumes that the meltable ring has melted. Similar to FIG. 2, the valve assembly shown in FIG. 4 includes bonnet 20, bonnet shroud 25, bonnet backseat 28, bonnet cap shoulder 13, sleeve 14, stem 30, stem backseat 32, cavity 8, flowway 5, upper seat 50, lower seat 52, and weep hole 45.

As the meltable ring melts, the stem backseat 32 abuts or contacts the bonnet backseat 28, and consequently, stem 30 shifts in the bonnet. Furthermore, as stem 30 shifts in the bonnet, slab gate 40 ceases to abut edge 9 of cavity 8. Following a shifting of slab gate 40, a weep hole 45 may communicate between cavity 8 and flowway 5. Consequently, any excess pressure in cavity 8 may be vented upstream through weep hole 45 into flowway 5. As pressure increases in cavity 8 due to a temperature increase, the increased pressure is vented upstream through weep hole 45.

FIG. 5 depicts another embodiment gate valve assembly in the closed pressure relief position. FIG. 5 does not include a meltable ring because FIG. 5 assumes that the meltable ring has melted. Similar to FIG. 2, the valve assembly shown in FIG. 5 includes bonnet 20, bonnet shroud 25, bonnet backseat 28, bonnet cap shoulder 13, sleeve 14, stem 30, stem backseat 32, cavity 8, flowway 5, upper seat 50, lower seat 52, and weep hole 45.

As the meltable ring melts, bonnet cap shoulder 13 abuts or contacts the sleeve 14, and consequently, stem 30 shifts in the bonnet. Furthermore, as stem 30 shifts in the bonnet, slab gate ceases 40 to abut edge 9 of cavity 8. Following a shifting of slab gate 40, a weep hole 45 may communicate between cavity 8 and flowway 5. Consequently, any excess pressure in cavity 8 may be vented upstream through weep hole 45 into flowway 5. As pressure increases in cavity 8 due to a temperature increase, the increased pressure is vented upstream through weep hole 45.

The foregoing disclosure and description of the invention is illustrative and explanatory of preferred embodiments. It would be appreciated by those skilled in the art that various changes in the size, shape of materials, as well in the details of the illustrated construction or combination of features discussed herein maybe made without departing from the spirit of the invention, which is defined by the following claims. One skilled in the art with the benefit of this disclosure will recognize that the disclosed invention may applied to actuated valves and to manual valves.

The invention, therefore, is well adapted to carry out the objects and to attain the ends and advantages mentioned, as well as others inherent therein. While the invention has been depicted, described and is defined by reference to exemplary embodiments of the invention, such references do not imply a limitation on the invention, and no such limitation is to be inferred. The invention is capable of considerable modification, alternation and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A gate valve assembly, comprising:
a flowway;
a cavity intersecting the flowway; and
a slab gate movable within the cavity between an open position, a closed position, and a relief position such that the open position allows fluid flow through the flowway, the closed position restricts fluid flow through the flowway, and the relief position allows fluid flow between the cavity and the flowway.

2. The gate valve assembly of claim 1, further comprising a stem in mechanical communication with the slab gate so as to move the slab gate between the open position and the closed position.

3. The gate valve assembly of claim 1, further comprising a retainer in mechanical communication with the slab gate so as to control movement of the slab gate between the closed position and the relief position, the retainer changing from a solid to one of a liquid or gas in the presence of heat.

4. The gate valve assembly as claimed in claim 3, wherein the retainer comprises a ring.

5. The gate valve assembly as claimed in claim 3, wherein the retainer comprises lead (Pb) and Bismuth (Bi).

6. The gate valve assembly as claimed in claim 3, wherein the retainer comprises a material having a melting temperature between 240° F. and 270° F.

7. The gate valve assembly as claimed in claim 1, further comprising a biaser of the slab gate toward the relief position.

8. The gate valve assembly as claimed in claim 7, wherein the biaser comprises a slab gate configuration with surfaces exposed to the cavity such that fluid pressure in the cavity acts on the surfaces to apply a force to the slab gate.

9. The gate valve assembly as claimed in claim 1, wherein the slab gate comprises a weep hole extending between the cavity and the flowway when the slab gate is in the relief position.

10. A gate valve assembly, comprising:
a flowway;
a cavity intersecting the flowway;
a slab gate movable within the cavity between an open position, a closed position, and a relief position such that the open position allows fluid flow through the flowway, the closed position restricts fluid flow through the flowway, and the relief position allows fluid flow between the cavity and the flowway;
a stem in mechanical communication with the slab gate so as to move the slab gate between the open position and the closed position;
a retainer in mechanical communication with the slab gate so as to control movement of the slab gate between the closed position and the relief position, the retainer changing from a solid to one of a liquid or gas in the presence of heat; and
a biaser of the slab gate toward the relief position.

11. A gate valve assembly as claimed in claim 10, wherein the retainer is a ring comprising lead (Pb) and Bismuth (Bi) and having a melting temperature between 240° F. and 270° F.

12. The gate valve assembly as claimed in claim 10, wherein the biaser comprises a slab gate configuration with surfaces exposed to the cavity such that fluid pressure in the cavity acts on the surfaces to apply a force to the slab gate.

13. A method for controlling fluid flow through a flowway, the method comprising:
intersecting a cavity with the flowway;
positioning a slab gate across the flowway, wherein the slab gate has open, closed, and relief positions such that the open position allows fluid flow through the flowway, the closed position restricts fluid flow through the flowway, and the relief position allows fluid flow between the cavity and the flowway;
maintaining the slab gate in the closed position with a retainer;
removing the retainer; and
biasing the slab gate toward the relief position.

14. A method for controlling fluid flow through a flowway as claimed in claim 13, wherein the positioning a slab gate across the flowway comprises restricting fluid flow between a downstream side of the flowway and the cavity, and restricting fluid flow between an upstream side of the flowway and the cavity.

15. A method for controlling fluid flow through a flowway as claimed in claim 13, wherein the maintaining the slab gate in the closed position with a retainer comprises holding the slab gate against a fluid pressure in the cavity, wherein the fluid pressure biases the slab gate toward the relief position.

16. A method for controlling fluid flow through a flowway as claimed in claim 13, wherein the removing the retainer comprises melting a retainer comprising lead (Pb) and Bismuth (Bi).

17. A method for controlling fluid flow through a flowway as claimed in claim 13, wherein the removing the retainer comprises heating the retainer to a temperature greater than 250° F.

18. A method for controlling fluid flow through a flowway as claimed in claim 13, wherein the removing the retainer comprises melting a eutectic retainer.

19. A method for controlling fluid flow through a flowway as claimed in claim 13, wherein the biasing the slab gate toward the relief position comprises biasing with fluid pressure in the cavity.
